(19) United States
(12) Patent Application Publication
(10) Pub. No.: US 2025/0271306 A1
(43) Pub. Date: Aug. 28, 2025

(54) DISPLAY LIGHT MEASURING APPARATUS AND LIGHT MEASURING METHOD

(71) Applicant: KONICA MINOLTA, INC., Tokyo (JP)

(72) Inventor: Satoshi MASUDA, Osaka (JP)

(73) Assignee: KONICA MINOLTA, INC., Tokyo (JP)

(21) Appl. No.: 19/055,303

(22) Filed: Feb. 17, 2025

(30) Foreign Application Priority Data
Feb. 28, 2024 (JP) 2024-028919

(51) Int. Cl. G01J 3/50; G01J 1/02; G01J 3/02

(52) U.S. Cl. CPC G01J 3/506; G01J 1/0228; G01J 3/0297

(57) ABSTRACT

A display light measuring apparatus includes: an optical sensor; an integration circuit that includes an integration capacitor and accumulates electric charge output from the optical sensor; a light quantity limiter that is capable of limiting a quantity of light to the optical sensor; and a hardware processor that activates the light quantity limiter to limit the quantity of light during non-measurement operation and cancels the limitation of the quantity of light by the light quantity limiter during measurement operation.

### CROSS-REFERENCE TO RELATED APPLICATION

The disclosure of Japanese Patent Application No. 2024-028919 filed on Feb. 28, 2024, including description, claims, drawings, and abstract, is incorporated herein by reference in its entirety.

### BACKGROUND OF THE INVENTION

### 1. Technical Field

The present invention relates to a display light measuring apparatus and a light measuring method for measuring the luminance, color, etc. of a display.

### 2. Description of Related art

As the light measuring apparatus as described above, a display color analyzer (CA-410 manufactured by Konica Minolta, Inc. as an example) is known, for example. Such a display color analyzer includes an optical sensor equivalent to a spectral responsivity therein and acquires a stimulus value.

There are roughly two kinds of methods for acquiring a stimulus value, that is, a sequential acquisition method for acquiring an instantaneous value and an integral acquisition method for acquiring an integral value for a determined time. The sequential acquisition method is excellent in high-speed performance. An integration circuit is suitable and widely used as means for measuring a wide range of luminance from low luminance to high luminance with a high S/N ratio. In particular, in recent years, a technology for reducing a dark current and circuit noise has advanced, and thus, the integration circuit is becoming able to perform integration for a long time. Since a weaker photocurrent can be handled, further improvement in performance in a low luminance region is expected.

Japanese Unexamined Patent Application Publication No. 2005-321313 discloses a light detection device that includes an integration circuit as described above and has a wide dynamic range and an improved S/N ratio.

Further, International Publication No. 2018-198674 discloses a light detection device capable of measuring luminance in a wide range and with a high S/N ratio without increasing the cost.

As a method for suppressing a measurement error caused by a dark current of an optical sensor and an offset of a circuit, there is zero calibration.

The zero calibration is a process of preparing an output value (zero calibration value) in a state where an index value is to be set to a zero value, and subtracting the zero calibration value from the output value (acquired with an optical path being opened) at the time of light measurement.

The zero calibration value is generated from a dark output value. The dark output value is an output value acquired in a light-shielded state in which the optical path to the optical sensor is closed. The dark output value is acquired under conditions that can generate a zero calibration value corresponding to photometric conditions (e.g., integration time and capacitance of an integration circuit (circuit gain)) used in light measurement.

For example, in a system having a plurality of circuit gains, zero calibration values respectively corresponding to the circuit gains are required, so that a plurality of dark output values is to be acquired as a condition. Basically, the dark output is acquired for each circuit gain, but if the dark output can be shared by a plurality of circuit gains, the number of times the dark output value is acquired can be reduced.

The integration time is also similar to the circuit gain and needs to be acquired under conditions that can generate a zero calibration value corresponding to photometric conditions at the time of light measurement. It is not always necessary to set the same photometric conditions, and it is sufficient that substantially equal values are acquired such that an error can be ignored.

There are roughly two kinds of timings for acquiring the dark output value for the zero calibration. The first is a method for acquiring a dark output value for each light measurement (immediate type). The second is a method for acquiring and holding a dark output value in advance prior to the execution of measurement (prior type).

The zero calibration of an immediate type is performed continuously with light measurement immediately before or immediately after the light measurement. The zero calibration executed immediately after the light measurement provides an advantage that only one condition (only a condition same as that for the previous light measurement) is set for acquiring a dark output value, because the photometric condition used for the light measurement is known.

In the prior type zero calibration, the dark output value is generally acquired at, for example, the following timings (1) to (3), that is, (1) at the time of activation, (2) at a timing at which an output value of a temperature sensor exceeds an allowable range with reference to a value at the time of the previous zero calibration (this is performed for the purpose of reducing a drift error), and (3) at a timing at which a user's request is issued. Since photometric conditions at the time of light measurement are unknown, it is common to acquire all dark output values in advance for a plurality of main conditions.

In addition, for the purpose of extending the measurement luminance range, a mechanism for limiting a quantity of light incident on the optical sensor by, for example, light reduction means or the like may be provided.

A light measuring apparatus provided with an integration circuit needs a reset operation for changing the potential of an integration capacitor in the integration circuit to a reference potential before the execution of measurement.

In a case where a light measuring apparatus provided with an integration circuit is used and the integration circuit is operated under the following condition A or B, the integration operation is undesirably started in a state where the integration capacitor does not reach the reference potential (a state where an electric charge signal remains).

A: When zero calibration is performed in a state where a display to be measured is turned on (at the time of zero calibration)

B: When measurement is performed immediately after the brightness of the display is reduced (at the time of measurement)

Measurement using output values acquired under conditions such as the conditions A and B described above may have an error due to a slight amount of remaining electric charges (residual electric charges).

For example, in the case of “A: at the time of zero calibration”, the acquired dark output value has a slight error due to the residual electric charges, and therefore, a slight error occurs when the measurement in a low luminance range is performed with the zero calibration value. In addition, in the case of “B: at the time of measurement”, a slight error due to the residual electric charges is included in the light output value in the measurement in the low luminance range.

Conventionally, the measurement of a display has a limitation in low luminance performance that can be expressed. The error due to this slight residual electric charges is not a problem.

However, in recent years, the dynamic range of brightness that can be expressed by a display has been extended on both the high luminance side and the low luminance side. For this reason, there is a problem in which an error due to the slight residual electric charges at the time of zero calibration or measurement cannot be ignored.

### SUMMARY OF THE INVENTION

An object of the present invention is to provide a display light measuring apparatus and a measuring method that can suppress an error due to residual electric charges of an integration capacitor of an integration circuit.

A first aspect of the present invention relates to
a display light measuring apparatus including:
an optical sensor;
an integration circuit that includes an integration capacitor and accumulates electric charge output from the optical sensor;
a light quantity limiter that is capable of limiting a quantity of light to the optical sensor; and
a hardware processor that activates the light quantity limiter to limit the quantity of light during non-measurement operation and cancels the limitation of the quantity of light by the light quantity limiter during measurement operation.

A second aspect of the present invention relates to
a display light measuring method performed by a display light measuring apparatus that includes
an optical sensor,
an integration circuit that includes an integration capacitor and accumulates electric charge output from the optical sensor, and
light quantity limiter that is capable of limiting a quantity of light to the optical sensor, the method including:
activating the light quantity limiter to limit the quantity of light during non-measurement operation; and
canceling the limitation of the quantity of light by the light quantity limiter during measurement operation.

### BRIEF DESCRIPTION OF THE DRAWINGS

The advantages and features provided by one or more embodiments of the present invention will become more fully understood from the detailed description given hereinbelow and the appended drawings which are given by way of illustration only, and thus are not intended as a definition of the limits of the present invention.

FIG. 1 is a block diagram illustrating a configuration of a display light measuring apparatus 1 according to an embodiment of the present invention;

FIG. 2 is a state transition diagram of the display light measuring apparatus according to the first embodiment;

FIG. 3 is a flowchart illustrating operation when the display light measuring apparatus according to the first embodiment is activated;

FIG. 4 is a flowchart illustrating operation when the display light measuring apparatus according to the first embodiment performs zero calibration;

FIG. 5 is a flowchart illustrating operation in a standby state of the display light measuring apparatus according to the first embodiment;

FIG. 6 is a flowchart illustrating operation when the display light measuring apparatus according to the first embodiment executes measurement;

FIGS. 7A and 7B each illustrate an example of a timing chart of the operation of the display light measuring apparatus according to the first embodiment;

FIG. 8 is a state transition diagram of a display light measuring apparatus according to a second embodiment;

FIG. 9 is a flowchart illustrating operation when the display light measuring apparatus according to the second embodiment is activated;

FIG. 10 is a flowchart illustrating operation when the display light measuring apparatus according to the second embodiment performs zero calibration;

FIG. 11 is a flowchart illustrating operation when the display light measuring apparatus according to the second embodiment executes measurement; and

FIG. 12 is a flowchart illustrating operation when the display light measuring apparatus according to the second embodiment stops.

### DETAILED DESCRIPTION

Hereinafter, one or more embodiments of the present invention will be described with reference to the drawings. However, the scope of the invention is not limited to the disclosed embodiments.

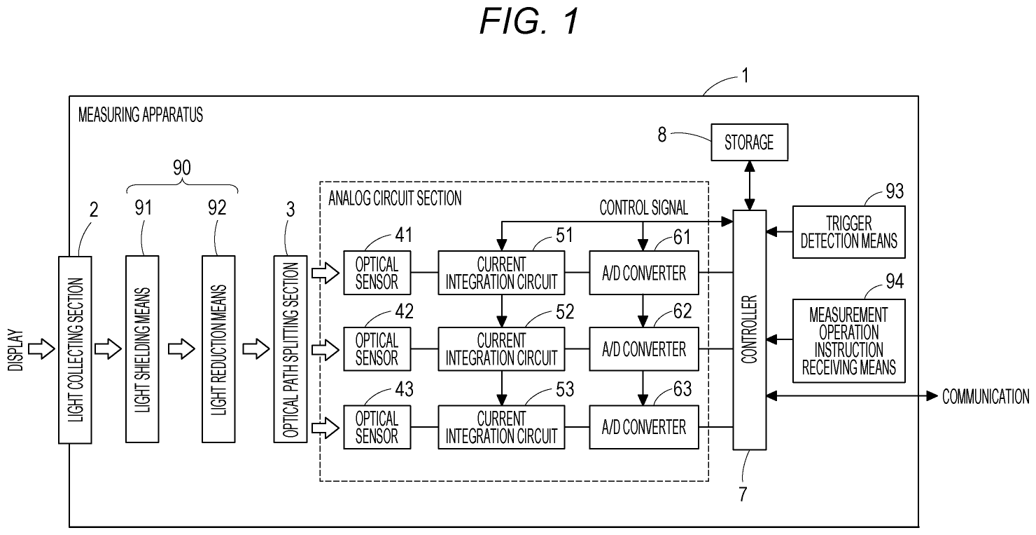

FIG. 1 is a block diagram illustrating the configuration of a display light measuring apparatus 1 according to an embodiment of the present invention.

The display light measuring apparatus 1 includes a light collecting section 2, a light quantity limiting means 90, an optical path splitting section 3, three optical sensors 41 to 43, three current integration circuits 51 to 53, three A/D converters 61 to 63, a controller 7, a storage 8, trigger detection means 93, and measurement operation instruction receiving means 94.

The light collecting section 2 includes a condenser lens and the like. The light collecting section 2 collects light emitted from a display which is an object to be measured.

In the present embodiment, the light quantity limiting means 90 is constituted by light shielding means 91 and light reduction means 92.

The light shielding means 91 is a member that shields incident light on the optical sensors 41 to 43 at the time of zero calibration, and is provided so as to be able to open and close an optical path for incident light on the optical sensors 41 to 43. As the light shielding means 91, a shutter is used, for example.

The light reduction means 92 is a member that limits a quantity of light incident on the optical sensors 41 to 43 in order to extend a measurement luminance range, and is provided in such a manner as to be insertable into and removable from the optical path for the incident light on the optical sensors 41 to 43. As the light reduction means 92, an ND filter is used, for example.

The light quantity limiting means 90 is a member that limits the quantity of incident light on the optical sensors 41 to 43 to a level at which an error due to residual electric charges does not become a problem. In this embodiment, two kinds of means, that is, the light shielding means 91 and the light reduction means 92 which are operated by different drive mechanisms, are provided as the light quantity limiting means 90. However, three or more kinds of means operated by separate drive mechanisms may be provided. Alternatively, only the light shielding means 91 may be provided. Other examples of the light quantity limiting means 90 include a variable aperture, a slit, and a filter member that is disposed to be insertable into and removable from an optical path.

The optical path splitting section 3 splits the optical path of light collected by the light collecting section 2 into three.

The optical sensors 41 to 43 receive the light of the respective optical paths split into three by the optical path splitting section 3. The optical sensors 41 to 43 may be a tristimulus value direct reading type or a spectroscopic type.

The current integration circuits 51 to 53 accumulate electric charges output from the respective optical sensors 41 to 43 in integration capacitors, and output output values corresponding to the amounts of the accumulated electric charges. In the present embodiment, each of the current integration circuits 51 to 53 has a plurality of selectable gains. That is, the capacitance of the integration capacitor can be changed in a plurality of stages.

The A/D converters 61 to 63 convert the output values of the current integration circuits 51 to 53 into digital signals.

The optical sensors 41 to 43, the current integration circuits 51 to 53, and part of the A/D converters 61 to 63 form an analog circuit section.

The controller 7 comprehensively controls the entire display light measuring apparatus 1. For example, the controller 7 calculates a stimulus value on the basis of whether or not the light quantity limiting means 91 and 92 are activated, the driving of the current integration circuits 51 to 53, and the output signal values of the A/D converters 61 to 63, or communicates with an external device (not illustrated) such as a personal computer. The stimulus values to be calculated include, for example, tristimulus values represented by luminance, chromaticity (xy), and XYZ. Furthermore, the controller 7 performs zero calibration. The zero calibration is performed by the controller 7 acquiring dark output values, which are output values of the quantity of incident light on the optical sensors 41 to 43, in a state where the light shielding means 91 shields incident light on the optical sensors 41 to 43. Then, the controller 7 calibrates the measurement value on the basis of the acquired dark output values.

The controller 7 includes a computer including a hardware processor such as a CPU and a ROM.

The storage 8 stores a control program of the display light measuring apparatus 1, calibration values for converting the output values of the optical sensors 41 to 43 into measurement index values, and the like.

The trigger detection means 93 detects a trigger signal. The trigger detection means 93 may be configured as a part of the function of the controller 7. One of the trigger signals is a signal serving as a trigger to activate the light quantity limiting means 90 so as to limit the quantity of light to the optical sensors 41 to 43. In other words, it is a signal for the display light measuring apparatus 1 to transition to the activation processing. This signal may be a signal generated with, as a trigger, an operation performed by the user on the display light measuring apparatus 1 to activate the display light measuring apparatus 1.

Another one of the trigger signals is a signal serving as a trigger to stop the operation of the display light measuring apparatus 1. This signal may be a signal generated in response to, as a trigger, an operation performed by the user on the display light measuring apparatus 1 to stop the operation of the display light measuring apparatus 1.

Specific examples of the trigger signal include a detection signal by an energization detector (e.g., USB bus power detection), an on/off signal of a power switch provided in the display light measuring apparatus 1, a detection signal of an acceleration sensor, and a detection signal of a posture sensor.

The measurement operation instruction receiving means 94 receives an instruction to perform light measurement. Specifically, the measurement operation instruction receiving means 94 receives a user's operation on an operation button for starting measurement. Alternatively, the measurement operation instruction receiving means 94 receives a measurement operation instruction from an IC board or the like that has received a measurement execution instruction from an information processing apparatus such as a PC. The measurement operation instruction receiving means may be configured as a part of the functions of the controller 7.

### First Embodiment

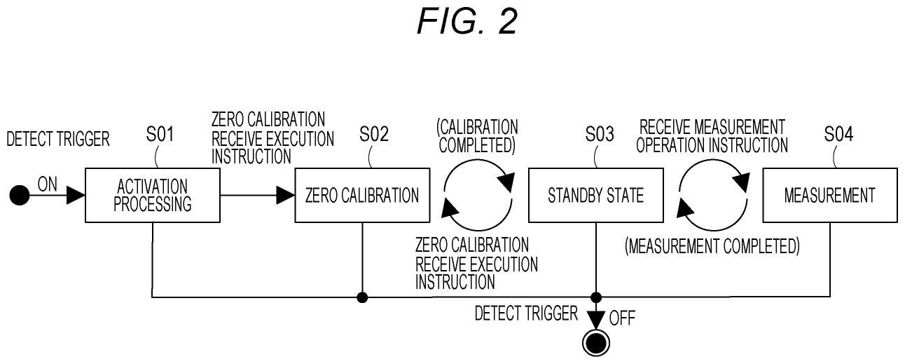

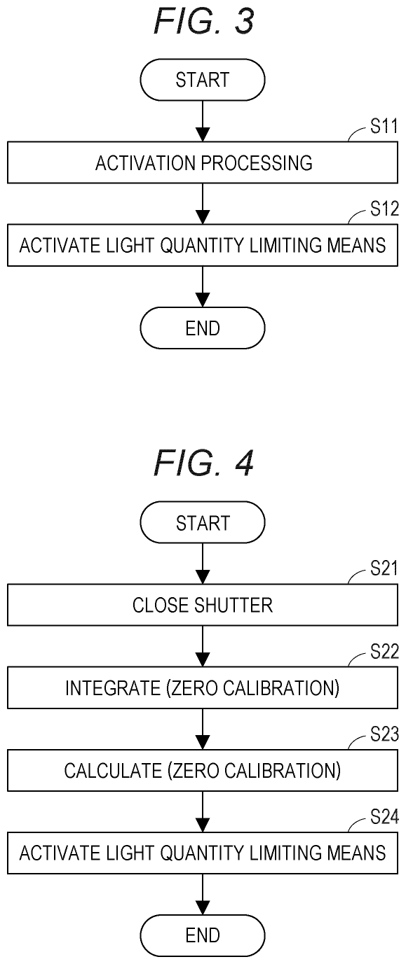

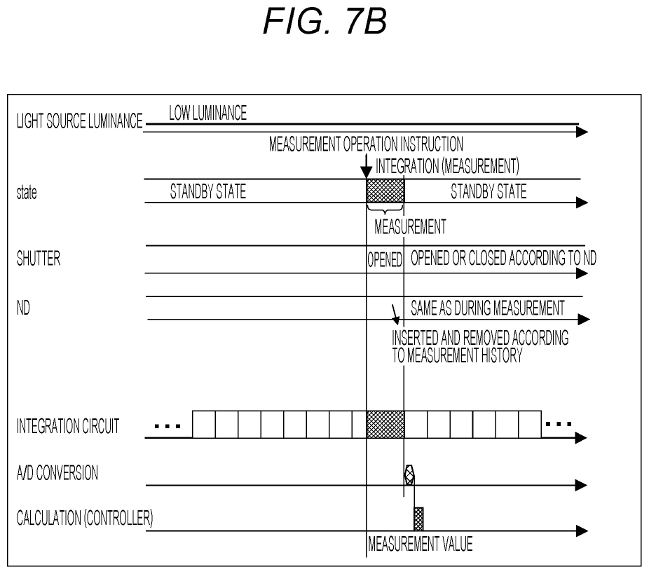

Next, the first embodiment of the display light measuring apparatus I will be described with reference to FIG. 2 that is a state transition diagram of the display light measuring apparatus 1, flowcharts in FIGS. 3 to 6, and examples of timing charts in FIGS. 7A and 7B.

The first embodiment is applied to a method (prior type) for acquiring and holding a dark output value for the zero calibration in advance before the execution of measurement. As described above, the dark output value is an output value acquired in a light-shielded state in which the optical path to the optical sensors 41 to 43 is closed.

In the state transition diagram of FIG. 2, when a power source is turned on, the display light measuring apparatus 1 detects that the power source has been turned on as a trigger signal and performs activation processing in step S01. Upon receiving a zero calibration execution instruction, the display light measuring apparatus 1 performs the zero calibration in step S02.

After completing the zero calibration, the display light measuring apparatus I enters a standby state in step S03. When receiving the zero calibration execution instruction in the standby state, the display light measuring apparatus 1 returns to step S02 and performs the zero calibration.

When receiving the measurement operation instruction in the standby state, the display light measuring apparatus 1 performs measurement in step S04. After completing the measurement, the display light measuring apparatus 1 returns to step S03 and enters the standby state again. Thereafter, the display light measuring apparatus 1 repeats standby of step S03, the zero calibration of step S02 as necessary, and the measurement of step S04. When the user turns off the power source, the display light measuring apparatus 1 detects that the power source has been turned off as a trigger signal and transitions to a stopped state.

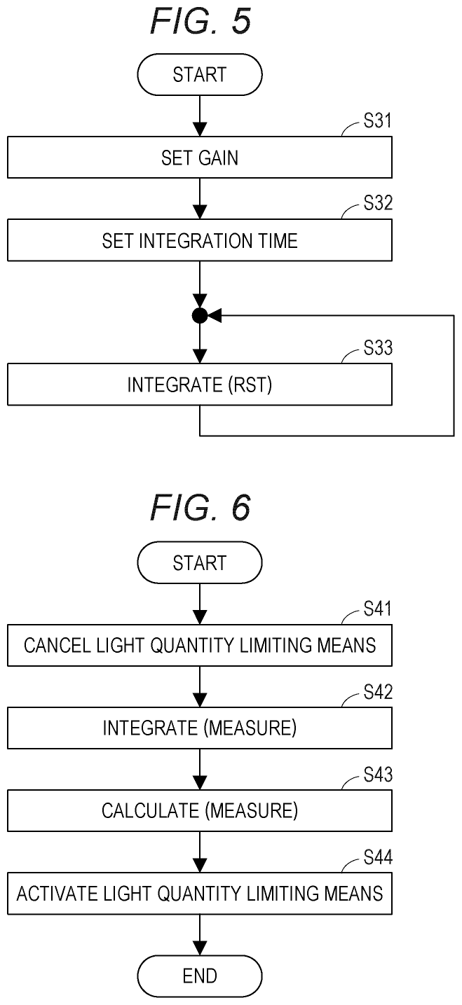

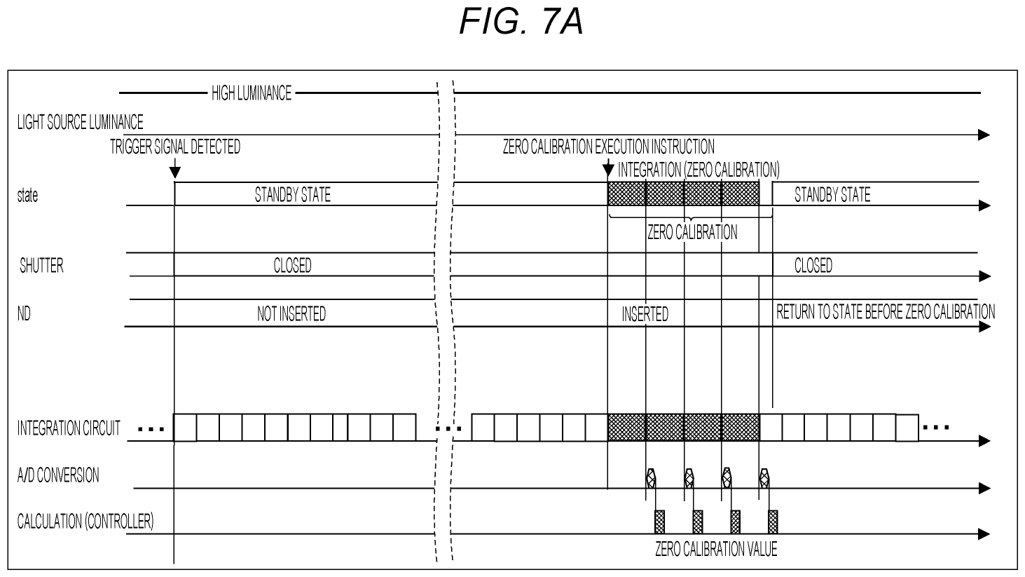

The flowchart of FIG. 3 illustrates the operation upon activation, the flowchart of FIG. 4 illustrates the operation at the time of zero calibration, the flowchart of FIG. 5 illustrates the operation in a standby state, and the flowchart of FIG. 6 illustrates the operation at the time of execution of measurement. The operations illustrated in the flowcharts of FIG. 3 and subsequent drawings are executed by the hardware processor of the controller 7 of the display light measuring apparatus 1 operating in accordance with an operation program.

FIG. 7A illustrates a timing chart upon activation, in the standby state, and at the time of zero calibration, and FIG. 7B illustrates a timing chart at the time of execution of the measurement.

### Operation Upon Activation

When the controller 7 detects, via the trigger detection means 93, a trigger signal generated when the power source is turned on, the controller 7 performs activation processing in step S11 in FIG. 3. As described above, the trigger signal is not limited to the signal generated when the power source is turned on, and may be any signal that triggers the display light measuring apparatus 1 to perform the activation processing.

The activation processing in step S11 is the same as that of the conventional display light measuring apparatus, so that the description thereof will be omitted. The operation of the display light measuring apparatus 1 after the completion of the activation processing is the same as the operation in the standby state described later.

In addition, the controller 7 activates the light quantity limiting means 90 in step S12 based on the detection of the trigger signal and limits the quantity of light to the optical sensors 41 to 43. The reason for this is to suppress an error due to residual electric charges generated at the time of zero calibration.

The light quantity limiting means 90 activated by the controller 7 may be at least one of the light shielding means (shutter) 91 and the light reduction means (ND filter) 92, but the controller 7 preferably activates the light shielding means 91. The reason is as follows. That is, the next state after the activation is the “zero calibration”, and the controller 7 needs to activate the light shielding means 91 at the time of the zero calibration. Therefore, the controller 7 does not need to newly activate the light shielding means 91 at the time of zero calibration by activating the light shielding means 91 in advance and keeping the activated state, and thus, the tact time can be accordingly shortened. In addition, the number of times of mechanical driving of the light quantity limiting means 90 is reduced as a whole compared to a case where the controller 7 operates the light reduction means 92 after activation and operates the light shielding means 91 at the time of zero calibration, whereby durability can also be improved.

Note that the timing of limiting the quantity of light in the activation processing is not limited thereto. For example, the activation processing of step S11 and the processing of activating the light quantity limiting means 90 of step S12 may be performed at the same time, or may be performed in reverse order.

### Operation at the Time of Zero Calibration

When receiving the instruction to execute the zero calibration, the controller 7 closes the light shielding means (shutter) 91 in order to acquire a dark output value in step S21 in FIG. 4. Note that step S21 is skipped when the controller 7 has already activated the light shielding means 91 in step S12 in FIG. 3. The present embodiment is configured such that the light reduction means 92 is also forcibly inserted into the optical path in order to reduce an error caused by leakage light. However, the light reduction means 92 may not be inserted in the optical path.

Next, in step S22, the controller 7 acquires a dark output value under a plurality of predetermined photometric conditions. In the present embodiment, as indicated in the timing chart of FIG. 7A, the controller 7 acquires the dark output value four times while switching the gains of the current integration circuits 51 to 53 under the condition that the exposure time is 1/30 [sec] (the integration is performed once). Since the light quantity limiting means 90 has already been activated upon activation of the display light measuring apparatus 1 to limit the quantity of incident light on the optical sensors 41 to 43, the residual electric charges of the integration capacitors of the current integration circuits 51 to 53 are sufficiently suppressed when the dark output value is acquired.

In step S23, the controller 7 performs calculation processing, if necessary, on the dark output value acquired in step S22, and generates a zero calibration value. Examples of the calculation processing include normalization by integration time. The generated zero calibration value is stored in the storage 8 or the like.

In step S24, since the next state is measurement, the controller 7 activates the light quantity limiting means 90 in order to suppress an error due to residual electric charges generated during the measurement. In a state where the optical paths to the optical sensors 41 to 43 have already been closed by the light shielding means 91 as in the present embodiment, the light-shielded state is held. Thus, it is not necessary to newly activate the light quantity limiting means 90, whereby the tact time can be shortened, and the drive mechanism of the light quantity limiting means 90 can be prevented from being worn.

On the other hand, the controller 7 retracts the light reduction means 92 from the optical path to return the light reduction means 92 to the state before the start of the zero calibration. Thus, the measurement to be performed next can be performed quickly as before the zero calibration. When the light reduction means 92 is not inserted into the optical path at the time of zero calibration, the light reduction means 92 is maintained in the non-inserted state.

Thereafter, the display light measuring apparatus 1 transitions to a standby state (step S03 in FIG. 2).

### Operation in Standby State

In the present embodiment, the current integration circuits 51 to 53 are operating even in the standby state. Since the operation of resetting the integration capacitances is executed by the operation of the current integration circuits 51 to 53, the current integration circuits 51 to 53 are prevented from becoming oversaturated. When the current integration circuits 51 to 53 become oversaturated, it takes time to return to an appropriate state. Furthermore, due to the process of step S24 in FIG. 4 or the process of step S44 in FIG. 6 to be described later, the light quantity limiting means 90 is in operation even in the standby state.

In step S31 in FIG. 5, the controller 7 sets the gain of each of the current integration circuits 51 to 53. In the standby state, the controller 7 sets the gains of the current integration circuits 51 to 53 to the minimum (the capacitance values of the integration capacitors are set to the maximum) in order to avoid the saturation of the current integration circuits 51 to 53 due to exposure with high luminance. When the current integration circuits 51 to 53 are saturated, the reset time is extended. However, it is not limited thereto. It is extremely unlikely to be problematic even if the controller 7 continues the previous setting without changing the gain setting of the current integration circuits 51 to 53, because the light quantity limiting means 90 is in the activated state.

Next, in step S32, the controller 7 sets integration conditions (integration time, integration cycle, and the like). In the present embodiment, the controller 7 sets both the integration time and the integration cycle to 0.3 msec.

Next, in step S33, the controller 7 performs photometry (integration) under the conditions determined in step S32. The controller 7 repeatedly performs the following procedures (1) to (3) until receiving a measurement execution instruction or a zero calibration execution instruction.

(1) The controller 7 starts integration after performing processing of resetting each of the current integration circuits 51 to 53.

(2) The controller 7 samples and holds the output values from the current integration circuits 51 to 53 when a predetermined time (0.3 msec) has elapsed.

(3) After completion of (2), the procedure returns to (1). For the purpose of reducing a load, the controller 7 does not convert the output values from the current integration circuits 51 to 53 acquired in (2) into digital data by the A/D converters 61 to 63.

### Operation at the Time of Execution of Measurement

Upon receiving the measurement operation instruction via the measurement operation instruction receiving means 94, the controller 7 cancels the limitation on the light quantity by the light quantity limiting means 90 in step S41 in FIG. 6 and starts exposure. Specifically, the controller 7 fully opens the light shielding means 91 and returns the light reduction means 92 to the state at the time of the previous measurement as illustrated in the timing chart of FIG. 7B.

Next, in step S42, the controller 7 executes measurement according to a normal procedure. Prior to the measurement, the controller 7 switches the gains of the current integration circuits 51 to 53 and derives photometric conditions as necessary, and then performs integration (measurement).

In the present embodiment, it is assumed that a display having a Vsync frequency of 60 Hz is measured, and the exposure time is set to 1/30 [sec] (the integration is performed once).

The integration is performed the number of times of measurement designated by the user. For example, in a case where the user designates ten consecutive measurements and the integration is performed twice per measurement, the number of times of integration is 2×10=20. In a state before the measurement, the light quantity limiting means 90 is operated to limit the quantity of light to the optical sensors 41 to 43. Since the measurement is performed from this state, errors due to the residual electric charges of the current integration circuits 51 to 53 are suppressed.

Next, in step S43, the controller 7 converts the output value acquired by the measurement in step S42 into a measurement index value (e.g., a luminance value or a chromaticity value). Specifically, the controller 7 performs zero calibration processing on the output value to calibrate an offset error, and subsequently, performs normal processing of converting and calculating an output value to convert the output value into a target index value.

In step S44, after completion of the designated measurement, the controller 7 activates the light quantity limiting means 90 in order to suppress an error due to residual electric charges in preparation for the next measurement.

In the present embodiment, for the purpose of improving the durability of each drive mechanism of the light quantity limiting means 90, the controller 7 activates the light quantity limiting means 90 including the light shielding means 91 and the light reduction means 92 as follows, to thereby distribute the number of times the light shielding means 91 and the light reduction means 92 are operated.

That is, in a case where the light reduction means 92 is retracted from the optical path during the measurement, the controller 7 activates the light shielding means 91 to close the optical path (the state of the light reduction means 92 is unchanged).

On the other hand, when the light reduction means 92 is inserted in the optical path during the measurement, the controller 7 maintains the insertion state of the light reduction means 92 (the states of the light shielding means 91 and the light reduction means 92 are both unchanged).

Note that the method for distributing the number of times the light shielding means 91 and the light reduction means 92 are activated is not limited thereto. For example, every time the light quantity limiting means 90 is activated, the controller 7 may switch and activate the light shielding means 91 and the light reduction means 92 in turn. Alternatively, the controller 7 may switch and activate the light shielding means 91 and the light reduction means 92 according to a ratio between the number of times the light shielding means 91 is activated and the number of times the light reduction means 92 is activated. For example, when the number of times the light shielding means 91 is activated is twice the number of times the light reduction means 92 is activated, the light shielding means 91 and the light reduction means 92 may be repeatedly activated in the order of the light reduction means 92, the light reduction means 92, and the light shielding means 91.

After the completion of step S44, the display light measuring apparatus 1 transitions to a standby state (step S03 in FIG. 2).

As described above, in the first embodiment, the light quantity limiting means 90 is activated based on the trigger signal at the time of activation of the display light measuring apparatus 1, and the quantity of light incident on the optical sensors 41 to 43 is limited. Furthermore, the light quantity limiting means 90 also operates to limit the quantity of light incident on the optical sensors 41 to 43 in the standby state, at the end of zero calibration, or at the end of measurement. Therefore, the zero calibration or measurement is performed with the residual electric charges remaining in the integration capacitors of the current integration circuits 51 to 53 being eliminated. As a result, errors in zero calibration and measurement due to residual electric charges are suppressed by a simple method.

### Second Embodiment

The second embodiment is applied to a method (immediate type) in which zero calibration is performed for each light measurement immediately before the light measurement.

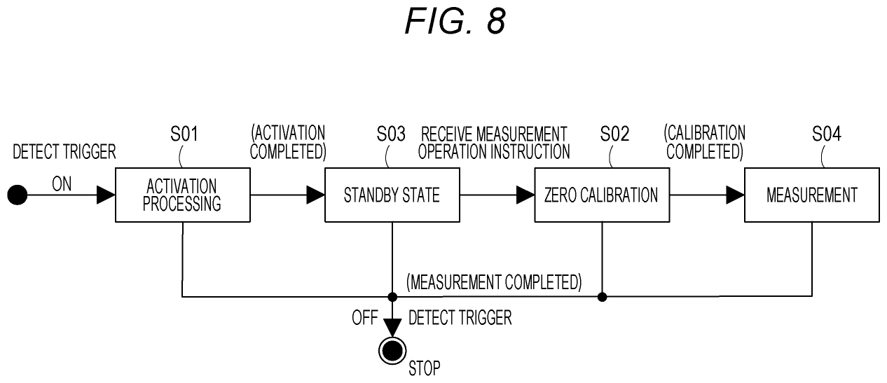

FIG. 8 is a state transition diagram of a display light measuring apparatus 1 according to the second embodiment. In the second embodiment, measurement is performed in step S04 immediately after the zero calibration is performed in step S02.

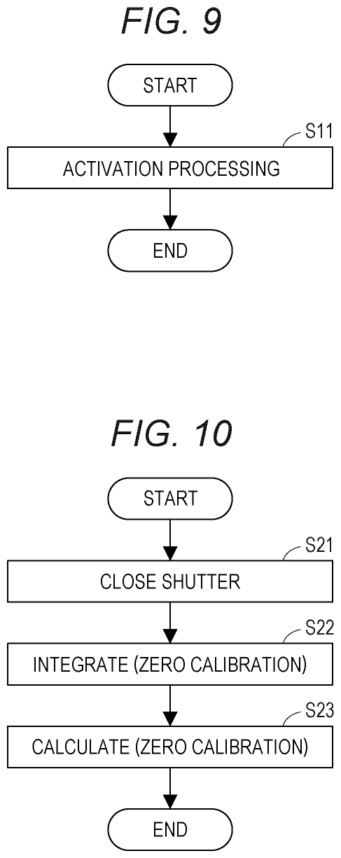

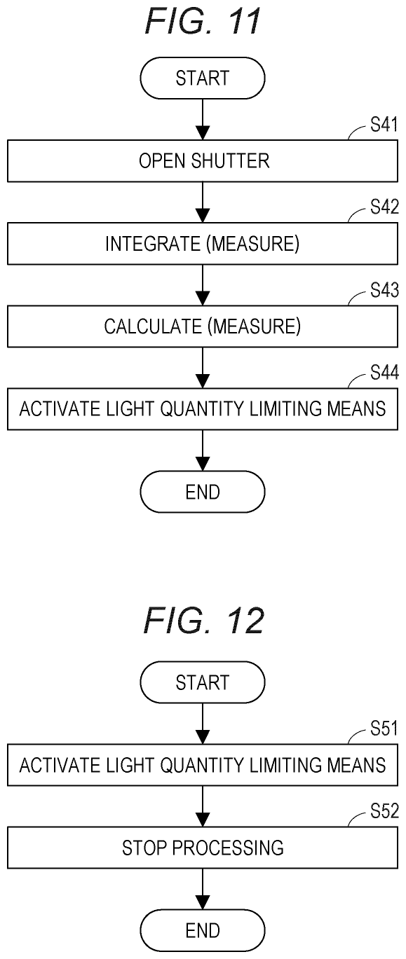

FIGS. 9 to 12 illustrate flowcharts. The flowchart of FIG. 9 illustrates operation upon activation, the flowchart of FIG. 10 illustrates operation at the time of zero calibration, the flowchart of FIG. 11 illustrates operation at the time of execution of measurement, and the flowchart of FIG. 12 illustrates operation when the display light measuring apparatus 1 is stopped.

The second embodiment is different from the first embodiment described above mainly in that the light quantity limiting means 90 operates when the display light measuring apparatus 1 is stopped, and that zero calibration and measurement are continuously performed. In order to activate the light quantity limiting means 90 when the display light measuring apparatus 1 stops, a monostable ND filter is used as the light reduction means 92 in the second embodiment. The monostable ND filter includes a mechanism for exerting an urging force in a direction in which the ND filter is inserted into the optical path. When the power supply to the display light measuring apparatus 1 is stopped, the light reduction means 92 is automatically inserted into the optical path by the urging force.

In the following description, only the differences from the first embodiment will be mainly described.

### Operation Upon Stop

When the user operates, for example, an operation stop button or turns off a power source in order to stop the operation of the display light measuring apparatus 1, this operation performed by the user is detected as a trigger signal by a trigger detection means. Based on the detection of the trigger signal, the controller 7 activates the light quantity limiting means 90 in step S51 in FIG. 12.

For example, when the supply of power is maintained as in the case where the stop button is operated, the controller 7 sends a control signal to, for example, the light reduction means 92 serving as the light quantity limiting means 90, to thereby change the light reduction means 92 into a state of being inserted into the optical path. When the supply of power is stopped, such as when the power source is turned off, the light reduction means 92 is mechanically inserted into the optical path by the urging force applied to the monostable light reduction means 92.

Next, in step S52, the controller 7 performs stop processing in a predetermined order. When there is no power supply, the stop processing is skipped. The details of the stop processing are the same as those in the prior art, and therefore will not be described.

### Operation Upon Activation

This operation is basically the same as that in the first embodiment. Note that, in the stopped state, the light quantity limiting means 90 has already been activated. Therefore, as indicated in the flowchart of FIG. 9, the process of operating the light quantity limiting means 90 in step S12 in the flowchart of FIG. 3 is not necessary.

### Operation in Standby State

This operation is the same as the operation in the standby state in the first embodiment indicated in the flowchart of FIG. 5. That is, the light quantity limiting means 90 is in operation.

### Operation at the Time of Zero Calibration

This operation is the same as that in the first embodiment except for the following points. That is, in the first embodiment, the light quantity limiting means 90 is operated in step S24 in FIG. 4. In the second embodiment, the “measurement” is subsequently performed, and thus, the process of step S24 in FIG. 4 is unnecessary and is deleted in the flowchart of FIG. 10.

### Operation at the Time of Execution of Measurement

This operation is the same as that in the first embodiment except for the following points. That is, in the first embodiment, the flowchart of FIG. 6 indicates “cancel light quantity limiting means” in step S41. In contrast, in the present embodiment, the measurement is performed continuously after the “zero calibration”, and thus, a process of opening the shutter (light quantity limiting means) 90 is performed in step S41 of the flowchart of FIG. 11.

In the second embodiment, when the display light measuring apparatus 1 is stopped, the light quantity limiting means 90 is operated, and the quantity of light incident on the optical sensors 41 to 43 is limited. Furthermore, the light quantity limiting means 90 is maintained in the operated state even after the display light measuring apparatus 1 is activated. The operation of the light quantity limiting means 90 is canceled at the time of measurement. Therefore, the zero calibration or measurement is performed with the residual electric charges remaining in the integration capacitors of the current integration circuits 51 to 53 being eliminated. As a result, errors in zero calibration and measurement due to residual electric charges are suppressed by a simple method.

### Other Embodiments

While the embodiments according to the present invention have been described above, the present invention is not limited to the above-described embodiments. As another embodiment, the user may be allowed to select whether to activate the light quantity limiting means 90 when the display light measuring apparatus is, for example, activated, performs measurement, or is stopped. For example, the user enables the operation of the light quantity limiting means 90 only when high-precision measurement is required, by which the light quantity limiting means 90 is not operated as usual when the demand for the precision is low. Thus, the opportunity for the light quantity limiting means 90 to operate is reduced, whereby the tact time is accordingly shortened, and the drive mechanism of the light quantity limiting means 90 is prevented from being worn.

Although the zero calibration is performed in the first and second embodiments, the measurement may be performed without performing the zero calibration.

Although one or more embodiments of the present invention have been described and illustrated in detail, the disclosed embodiments are made for purposes of illustration and example only and not limitation. The scope of the present invention should be interpreted by terms of the appended claims.

What is claimed is:

1. A display light measuring apparatus comprising:
an optical sensor;
an integration circuit that includes an integration capacitor and accumulates electric charge output from the optical sensor;
a light quantity limiter that is capable of limiting a quantity of light to the optical sensor; and
a hardware processor that activates the light quantity limiter to limit the quantity of light during non-measurement operation and cancels the limitation of the quantity of light by the light quantity limiter during measurement operation.

2. The display light measuring apparatus according to claim 1, wherein
the hardware processor detects a trigger signal that triggers the light quantity limiter to operate so as to limit the quantity of light,
receives an instruction to perform the measurement operation,
activates the light quantity limiter to limit the quantity of light based on the detection of the trigger signal, and
cancels the limitation of the quantity of light by the light quantity limiter based on the received instruction to perform the measurement operation.

3. The display light measuring apparatus according to claim 2, wherein the trigger signal is a signal generated with, as a trigger, an operation performed by a user on the display light measuring apparatus to activate the display light measuring apparatus.

4. The display light measuring apparatus according to claim 1, wherein
the hardware processor
receives an instruction to perform the measurement operation,
cancels the limitation of the quantity of light by the light quantity limiter based on the received instruction to perform the measurement operation, and
activates the light quantity limiter to limit the quantity of light at an end of the measurement operation.

5. The display light measuring apparatus according to claim 1, wherein
the hardware processor
detects a trigger signal that triggers the display light measuring apparatus to stop,
receives an instruction to perform the measurement operation,
cancels the limitation of the quantity of light by the light quantity limiter based on the received instruction to perform the measurement operation, and
activates the light quantity limiter to limit the quantity of light based on the detection of the trigger signal.

6. The display light measuring apparatus according to claim 5, wherein the trigger signal is a signal generated with, as a trigger, an operation performed by a user on the display light measuring apparatus to stop the display light measuring apparatus.

7. The display light measuring apparatus according to claim 1, wherein
the hardware processor
performs zero calibration,
receives an instruction to perform the measurement operation, and
activates the light quantity limiter to limit the quantity of light at an end of the measurement operation performed based on the received instruction to perform the measurement operation, and at an end of the zero calibration.

8. The display light measuring apparatus according to claim 1, wherein
the hardware processor
performs zero calibration,
receives an instruction to perform the measurement operation,
acquires a zero calibration value based on the received instruction to perform the measurement operation, and
cancels the limitation of the quantity of light by the light quantity limiter and starts the measurement operation at an end of acquisition of the zero calibration value.

9. A display light measuring method performed by a display light measuring apparatus that includes
an optical sensor,
an integration circuit that includes an integration capacitor and accumulates electric charge output from the optical sensor, and
light quantity limiter that is capable of limiting a quantity of light to the optical sensor, the method comprising:
activating the light quantity limiter to limit the quantity of light during non-measurement operation; and
canceling the limitation of the quantity of light by the light quantity limiter during measurement operation.

10. The display light measuring method performed by the display light measuring apparatus according to claim 9, further comprising:
detecting a trigger signal that triggers the light quantity limiter to operate so as to limit the quantity of light;
receiving an instruction to perform the measurement operation;
activating the light quantity limiter to limit the quantity of light based on the detection of the trigger signal; and
canceling the limitation of the quantity of light by the light quantity limiter based on the instruction.

11. The display light measuring method performed by the display light measuring apparatus according to claim 10, wherein the trigger signal is a signal generated with, as a trigger, an operation performed by a user on the display light measuring apparatus to activate the display light measuring apparatus.

12. The display light measuring method performed by the display light measuring apparatus according to claim 9, further comprising:
receiving an instruction to perform the measurement operation;
canceling the limitation of the quantity of light by the light quantity limiter based on the instruction; and
activating the light quantity limiter to limit the quantity of light at an end of the measurement operation.

13. The display light measuring method performed by the display light measuring apparatus according to claim 9, further comprising:
detecting a trigger signal that triggers the display light measuring apparatus to stop;
receiving an instruction to perform the measurement operation;
canceling the limitation of the quantity of light by the light quantity limiter based on the instruction; and
activating the light quantity limiter to limit the quantity of light based on the detection of the trigger signal by trigger detection means.

14. The display light measuring method performed by the display light measuring apparatus according to claim 13, wherein the trigger signal is a signal generated with, as a trigger, an operation performed by a user on the display light measuring apparatus to stop the display light measuring apparatus.

15. The display light measuring method performed by the display light measuring apparatus according to claim 9, further comprising:
performing zero calibration;
receiving an instruction to perform the measurement operation; and
activating the light quantity limiter to limit the quantity of light at an end of the measurement operation performed based on the instruction and at an end of the zero calibration.

16. The display light measuring method performed by the display light measuring apparatus according to claim 9, further comprising:
performing zero calibration;
receiving an instruction to perform the measurement operation;
acquiring a zero calibration value based on the instruction; and
canceling the limitation of the quantity of light by the light quantity limiter and starting the measurement operation at an end of acquisition of the zero calibration value.
